(19) United States
(12) Patent Application Publication
(10) Pub. No.: US 2012/0160057 A1
(43) Pub. Date: Jun. 28, 2012

(54) TRANSFER CASE

(75) Inventors: Wally Couto, Burlington (CA); John Goddard, Burlington (CA)

(73) Assignee: MMC Technologies

(21) Appl. No.: 12/977,960

(22) Filed: Dec. 23, 2010

(51) Int. Cl. F16H 57/02

(52) U.S. Cl. 74/665 F; 74/640

(57) ABSTRACT

A transfer case comprises a casing, an input shaft extending from outside the casing into the casing and at least one output shaft extending from inside the casing to outside the case. The input shaft is rotationally coupled to the output shaft(s) for transferring rotation from the input shaft to the output shaft(s). Various types of mechanical arrangements can be used to couple the input shaft to the output shaft(s). The input shaft and the output shaft(s) are rotatably supported in the casing by opposed pairs of tapered roller bearings oriented so that the narrow ends of the tapered roller bearings in each pair of tapered roller bearings point away from one another, and the tapered roller bearings are each squeezed between the casing and their respective shaft. The tapered roller bearings are adjustable to limit play between the shafts and the casing.

### FIELD OF INVENTION

The present invention relates to motor vehicles, and more particularly to a transfer case for motor vehicles.

### BACKGROUND OF THE INVENTION

In conventional transfer cases used on heavy vehicles, the annular ball bearings used to support the input shaft and the output shaft(s) can be subjected to significant stresses, which can lead to wear and consequent loosening of the bearings. This in turn leads to vibration that can damage the transfer case and can also cause unwanted noise.

### SUMMARY OF THE INVENTION

The present invention replaces the conventional ball bearings used to support the input and output shafts in a transfer case with opposed sets of tapered roller bearings squeezed between their respective shafts and the casing of the transfer case and oriented with their narrow ends facing away from each other, and provides for adjustment of the tapered roller bearings to offset loosening.

In one aspect, the present invention is directed to a transfer case, comprising a casing, an input shaft and at least one output shaft. A rotational coupling inside the casing rotationally couples the input shaft to the at least one output shaft, and the input shaft and the at least one output shaft each have an end disposed inside the housing and are rotatably supported by a respective opposed pair of tapered roller bearings extending between the casing and the respective shaft. The tapered roller bearings are oriented so that the narrow ends of the tapered roller bearings in each pair of tapered roller bearings point away from one another, and each of the tapered roller bearings is squeezed between the casing and its respective shaft.

In one embodiment, the transfer case has one output shaft; in another embodiment the transfer case has two output shafts.

In one embodiment, the transfer case further comprises an adjustment mechanism for maintaining each of the tapered roller bearings being squeezed between the casing and its respective shaft. The adjustment mechanism may comprise the casing having at least one removably mounted bearing retention member providing access to a respective at least one of the tapered roller bearings to enable an annular shim to be interposed between one of the tapered roller bearings and its respective shaft.

In another aspect, the present invention is directed to a transfer case, comprising a casing, an input shaft extending from outside the casing to inside the casing and at least one output shaft extending from inside the casing to outside the casing. A rotational coupling inside the casing rotationally couples the input shaft to the at least one output shaft. Each of the input shaft and the at least one output shaft is rotatably supported by a respective opposed pair of tapered roller bearings extending between the casing and the respective shaft, with the tapered roller bearings being oriented so that the narrow ends of the tapered roller bearings in each pair of tapered roller bearings point away from one another. Each of the tapered roller bearings is squeezed between the casing and its respective shaft.

In one embodiment, the tapered roller bearings are interference fit over the shafts and interference fit into opposed receptacles in the casing.

In one embodiment, the input shaft and the at least one output shaft each include respective annular shoulders which cooperate with the casing to squeeze the tapered roller bearings. At least one annular shim may be interposed between at least one of the annular shoulders and at least one corresponding tapered roller bearing for squeezing that tapered roller bearing.

In one embodiment, the transfer case has one output shaft; in another embodiment the transfer case has two output shafts.

In one embodiment, the transfer case further comprises an adjustment mechanism for maintaining each of the tapered roller bearings being squeezed between the casing and its respective shaft. The adjustment mechanism may comprise the casing having at least one removably mounted bearing retention member providing access to a respective at least one of the tapered roller bearings to enable an annular shim to be interposed between one of the tapered roller bearings and its respective shaft.

In a further aspect, the present invention is directed to a transfer case. The transfer case comprises a casing and at least two shafts rotatably supported by the casing with one end of each shaft disposed inside the casing and one end of each shaft disposed outside the casing. The at least two shafts are rotationally coupled together by a rotational coupling inside the casing. Each of the at least two shafts is located relative to the casing by a pair of opposed tapered roller bearings extending between the casing and the respective shaft with narrow ends of the tapered roller bearings pointed away from one another, and the tapered roller bearings are adjustable to limit play between the shafts and the casing.

In one embodiment, the tapered roller bearings are interference fit over the shafts and interference fit into opposed receptacles in the casing.

In one embodiment, the input shaft and the at least one output shaft each include respective annular shoulders which cooperate with the casing to squeeze the tapered roller bearings.

In one embodiment, the tapered roller bearings are adjustable to limit play between the shafts and the casing by at least one removable bearing retention member providing access to a respective at least one of the tapered roller bearings to enable an annular shim to be interposed between one of the tapered roller bearings and its respective shaft.

In one embodiment, the at least two shafts comprise an input shaft and a single output shaft; in another embodiment, the at least two shafts comprise an input shaft and two output shafts.

### BRIEF DESCRIPTION OF THE DRAWINGS

These and other features of the invention will become more apparent from the following description in which reference is made to the appended drawings wherein:

FIG. 1 is an exemplary schematic representation of a first type of transfer case according to an aspect of the invention;

FIG. 2 is an exemplary schematic representation of a second type of transfer case according to an aspect of the invention;

FIG. 3 is an exemplary schematic representation of a third type of exemplary transfer case according to an aspect of the invention;

FIG. 4 is a perspective view showing an exemplary physical embodiment of a transfer case of the type shown in FIG. 3, with an input connector secured to the input shaft and a driveshaft connector secured to the output shaft;

FIG. 5 is a perspective view of the transfer case of FIG. 4 with part of the casing removed;

FIG. 6 is an exploded perspective view of the transfer case of FIG. 4;

FIG. 7 is a top view of the transfer case of FIG. 4 with an open cover plate thereof removed therefrom;

FIG. 8 is a side cut-away view of the transfer case of FIG. 4 with an input connector secured to the input shaft and a driveshaft connector secured to the output shaft;

FIG. 9 is a side cut-away view of the transfer case of FIG. 4, similar to that shown in FIG. 8 and with an input connector secured to the input shaft and a driveshaft connector secured to the output shaft, showing two annular shims installed in the transfer case to compensate for loosening of the bearings; and

FIG. 10 is an exploded perspective view of the transfer case of FIG. 4, similar to that shown in FIG. 6, showing two annular shims used to compensate for loosening of the bearings;

FIG. 11A is a first detailed side cut-away view of part of the transfer case of FIG. 4, enlarging a first portion of FIG. 8; and

FIG. 11B is a second more detailed side cut-away of part of the transfer case of FIG. 4, enlarging a first portion of FIG. 8.

### DETAILED DESCRIPTION

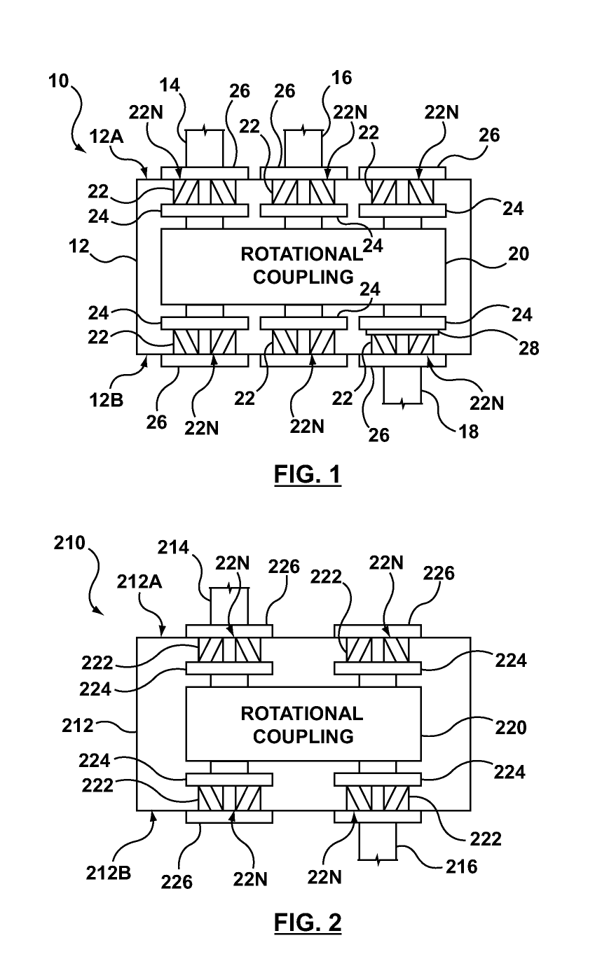

Reference is now made to FIG. 1, in which an exemplary transfer case according to an aspect of the present invention, indicated generally by the reference numeral 10, is shown in schematic form. The transfer case 10 shown in FIG. 1 is of the type used in a four-wheel drive system. The transfer case 10 comprises a casing 12 which, in operation, will contain a sufficient quantity of lubricant to lubricate the internal mechanical components thereof. An input shaft 14 extends from outside the casing 12 through a first side 12A of the casing 12 into the interior of the casing 12, and is in substantially sealing engagement with the casing 12. First and second output shafts 16, 18 extend from inside the casing 12 to outside the casing 12, also in substantially sealing engagement with the case. The first output shaft 16 drives the front wheels of a vehicle (not shown) and extends through the first side 12A of the casing 12, and the second output shaft 18 drives the rear wheels of the vehicle and extends from a second side 12B of the casing 12 opposite the first side 12A thereof.

The input shaft 14 is rotationally coupled to the first and second output shafts 16, 18 by a rotational coupling 20 for transferring rotation from the input shaft 14 to the first and second output shafts 16, 18. The rotational coupling 20 may be any one of a number of suitable mechanical arrangements, including gears and sprocket-and-chain arrangements. For example, the rotational coupling 20 may be configured to be selectably switched between a four-wheel drive mode in which the input shaft 14 simultaneously drives both of the output shafts 16, 18 and a two-wheel drive mode in which the input shaft drives one of the output shafts 16, 18 while permitting the other of the output shafts 16, 18 to rotate freely relative to the input shaft 14. Suitable implementations of the rotational coupling 20 will be apparent to one skilled in the art, now informed by the disclosure herein. The precise details of the rotational coupling 20 form no part of the present invention, and as such further details of the rotational coupling 20 are omitted.

The input shaft 14 and the first and second output shafts 16, 18 are each rotatably supported in the case 10 by a set of tapered roller bearings 22 oriented so that the narrow ends 22N of the tapered roller bearings 22 in each set point away from one another. As used herein, the term “narrow end”, when applied to a tapered roller bearing, refers to the end of the roller bearing toward which the outside surface of the inner ring, the roller cage and the inner surface of the outer ring are tapered. As shown schematically in FIG. 1, each of the tapered roller bearings 22 is squeezed between the casing 12 and the respective shaft 14, 16, 18, in the illustrated embodiment by way of opposed annular shoulders 24 on the respective shaft 14, 16, 18. In the exemplary embodiment shown schematically in FIG. 1, the casing 12 includes a plurality of bearing retention members 26 which apply pressure to the tapered roller bearings 22 so that each of the tapered roller bearings 22 is squeezed between the respective bearing retention member 26 and the respective annular shoulder 24 on the respective shaft 14, 16, 18. The casing 12 includes receptacles for receiving the tapered roller bearings 22 disposed at the locations where one of the shafts 14, 16, 18 extends through the casing 12.

In the illustrated embodiment, the bearing retention members 26 are removably mounted to the main body of the casing 12 to provide access to the tapered roller bearings 22. This permits ready repair of the transfer case 10 if one of the tapered roller bearings 22 should become loosened during operation of a motor vehicle of which the transfer case 10 forms a part. For example, in the embodiment illustrated in FIG. 1, one of the tapered roller bearings 22 on the second output shaft 18 became loosened. To correct this, an annular shim 28 is interposed between the relevant annular shoulder 24 and the corresponding tapered roller bearing 22 so as to continue to squeeze that roller bearing 22 between the second output shaft 18 and the casing 12. In the illustrated embodiment, the bearing retention member 22 is removed from the main body of the casing 12, the tapered roller bearing 22 is removed from the shaft 18 and an annular shim 28 is placed on the shaft 18 adjacent the annular shoulder 24. The same tapered roller bearing is then returned to the shaft 18, sandwiching the annular shim 28 between the annular shoulder 24 and the tapered roller bearing 22. The bearing retention member 26 is then re-secured to the main body of the casing 12, so that the tapered roller bearing 22 is now squeezed between the shaft 18, through the annular shoulder 24 and the annular shim 28, and the casing 12, so that the tapered roller bearing 22 is maintained tightly and rigidly in position relative to the casing 12. Although only a single shim 28 is shown, when a significant thickness of shims is to be added, shims of equal thickness should be placed on either side of the rotational coupling 20.

FIG. 2 is a schematic representation of a second exemplary transfer case according to an aspect of the present invention, indicated generally by the reference numeral 210. The transfer case 210 is generally similar in construction to the transfer case 10, and as such the same reference numerals are used to refer to corresponding elements, except with the prefix “2”.

In the transfer case 210, the input shaft 214 is, or is coupled to, the input shaft for the front wheels of a vehicle (not shown) or to the mainshaft. As such, the transfer case 210 has only a single output shaft 216, which drives the rear wheels of the vehicle. The input shaft 214 extends through the first side 212A of the casing 212, and the output shaft 216 extends through the second side 212B of the case opposite the first side 212A.

Similarly to the first embodiment 10, in the second embodiment of the transfer case 210 the input shaft 214 is rotationally coupled to the output shaft 216 by a rotational coupling 220 which can transfer rotation from the input shaft 214 to the output shaft 216. Like the rotational coupling 20 of the first embodiment, the rotational coupling 220 may be any one of a number of suitable mechanical arrangements, such as to selectively switch between the input shaft 214 driving the output shaft 216 and permitting the output shaft 216 to rotate freely. Such mechanical arrangements will be apparent to one skilled in the art, now informed by the disclosure herein and which form no part of the present invention.

As was the case with the first embodiment 10, in the second embodiment 210 the input shaft 214 and the output shaft 216 are rotatably supported in the case 210 by opposed sets of tapered roller bearings 222 oriented so that the narrow ends 222N of each roller bearing 222 in each set point away from each other, with each of the tapered roller bearings 222 squeezed between the casing 212 and an annular shoulder 224 on its respective shaft 214, 216. As with the first embodiment 10, in the second embodiment 210 one or more annular shims (not shown in FIG. 2) can be interposed between the annular shoulder 224 of one of the shafts 214, 216, 218 and the respective tapered roller bearing 222 to correct loosening of one of the tapered roller bearings 222.

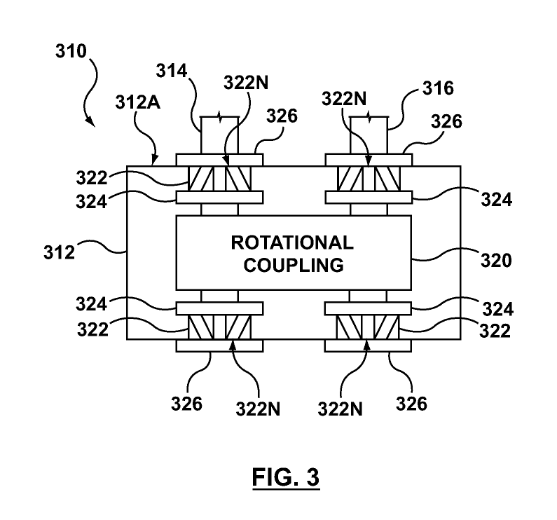

Reference is now made to FIG. 3, which shows a schematic representation of a third exemplary transfer case according to an aspect of the present invention, indicated generally by the reference numeral 310. The transfer case 310 may be used, for example, to adapt a rear wheel drive vehicle to become a front wheel drive vehicle, and is identical to the second embodiment 210 except that the both the input shaft 314 and the output shaft 316 extend through the first side 312A of the casing 312, and the rotational coupling 320 is limited to one in which the input shaft 314 always drives the output shaft 316. Accordingly, the same reference numerals are used to refer to corresponding elements, except with the prefix “3” instead of 2. Again, loosening of a tapered roller bearing 322 can be corrected by interposing one or more annular shims (not shown in FIG. 3) between the annular shoulder 324 of the relevant shaft 314, 316, 318 and the loosened tapered roller bearing 322.

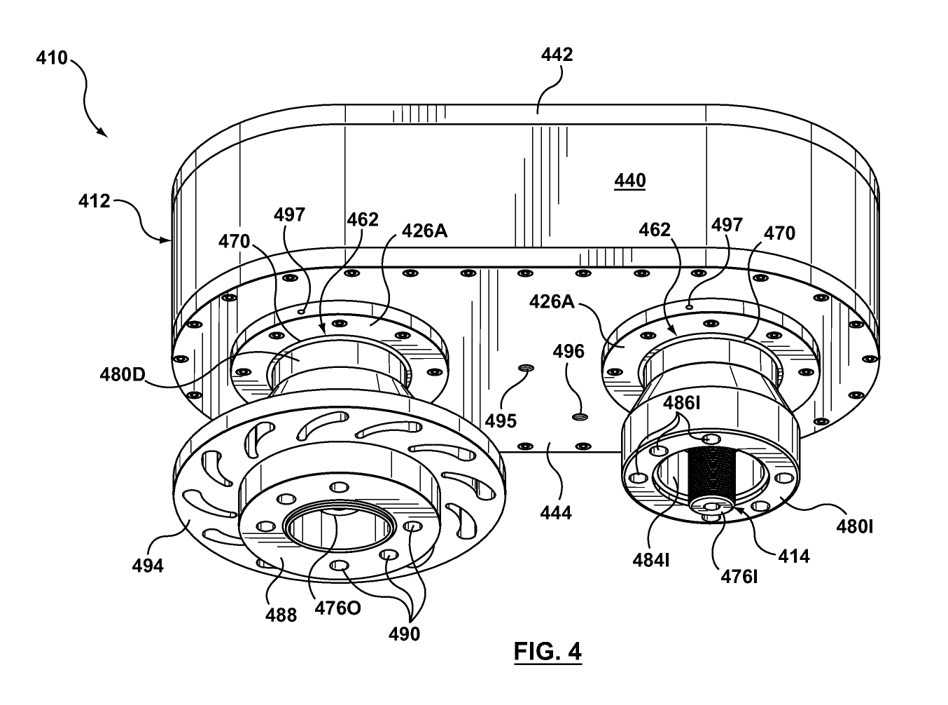

FIGS. 4 to 10 show an exemplary physical embodiment of a transfer case of the type shown schematically in FIG. 3, which is indicated generally by the reference numeral 410.

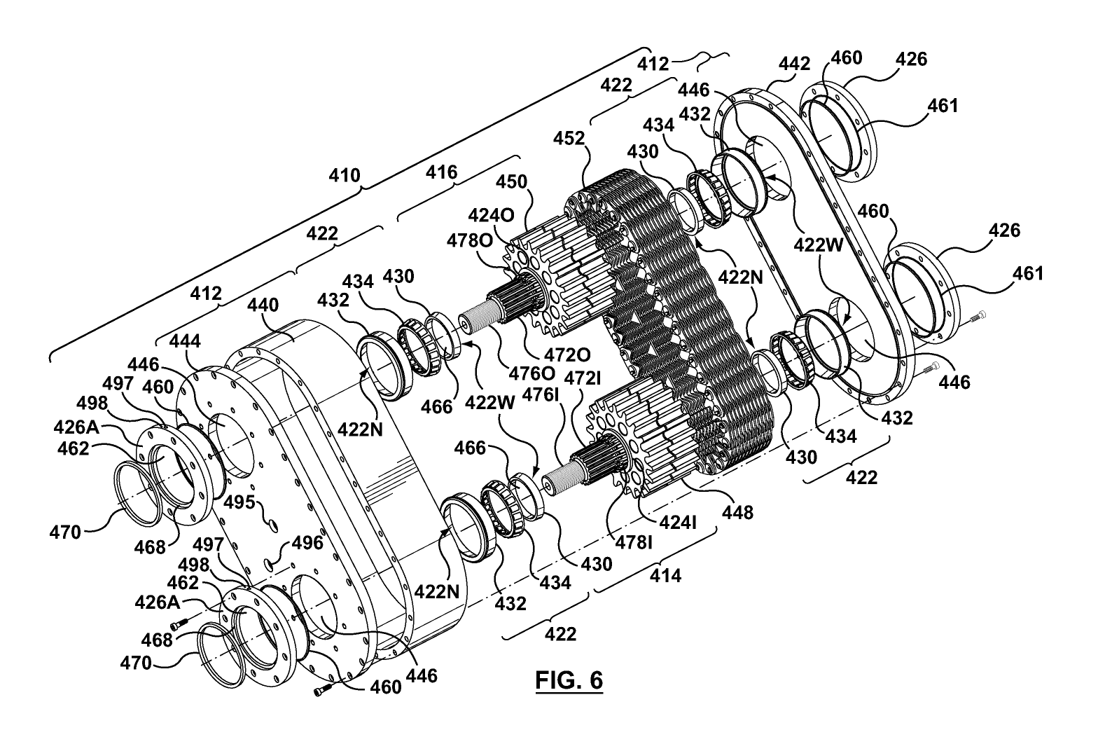

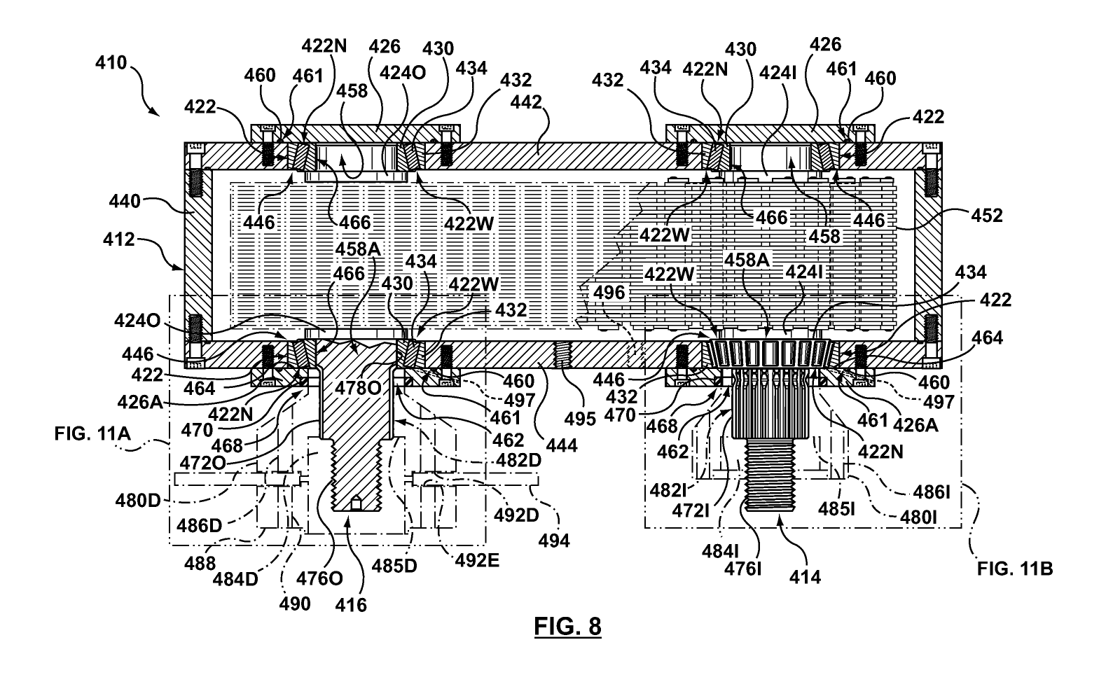

Referring first to FIGS. 6 and 8, the transfer case 410 comprises a sealed, enclosed casing 412 formed by an enclosure wall portion 440, two opposed elongated ovoid cover plates 442, 444 and bearing retention members comprising a set of two closed bearing retainer plates 426 and a set of two open bearing retainer plates 426A. The open bearing retainer plates 426A each include an aperture 462 for one of the shafts 414, 416. Each of the cover plates 442, 444 has a perimeter shape corresponding to the perimeter shape of the enclosure wall portion 440. The cover plates 442, 444 are bolted to opposed side edges of the enclosure wall portion 440, and the apertures 446 are arranged such that when the cover plates 442, 444 are bolted to the enclosure wall portion 440 each of the apertures 446 in one of the cover plates 442, 444 is opposed to and in registration with a corresponding aperture 446 in the other one of the cover plates 442, 444. The bearing retainer plates 426, 426A are removably secured to the cover plates 442, 444 over the apertures 446 in the cover plates 442, 444, which cooperate with the bearing retention members 426, 426A to define closed and open receptacles 458, 458A, respectively (see FIG. 8), for the tapered roller bearings 422. As is conventional, the tapered roller bearings 422 each comprise an inner ring 430, an outer ring 432 and a roller cage 434 disposed between the inner ring 430 and the outer ring 432. Typically, the inner ring 430 and roller cage 434 are secured together as a single assembly, and the outer ring 432 is removable therefrom, although the inner ring 430, roller cage 434 and outer ring 432 are shown in exploded form in FIG. 6 for illustrative purposes.

An input shaft 414 extends from outside the casing 412 through the aperture 462 in the open bearing retainer plate 426A and the aperture 446 in the cover plate 444 into an interior of the casing 412, and an output shaft 416 extends from inside the casing 412 through the aperture 446 in the cover plate 444 and the aperture 462 in the open bearing retainer plate 426A. Thus, the input shaft 414 and output shaft 416 are each rotatably supported by the casing 412 with one end of each shaft 414, 416 disposed inside the casing 412 and one end of each shaft 414, 416 disposed outside the casing. As will be explained in greater detail below, each of the shafts 414, 416 is located relative to the casing 412 by a pair of opposed tapered roller bearings 422 extending between the casing 412 and the respective shaft 414, 416.

Continuing to refer to FIGS. 6 and 8, the input shaft 414 has an input sprocket 448, an annular shoulder 424I adjacent the input sprocket 448, and a splined region 4721 having a plurality of longitudinally extending splines 474I. The splined region 472I extends from a position adjacent the annular shoulder 426I to a radially inwardly spaced threaded terminus 476I of the input shaft 414. When installed in the casing 12, the splined region 472I extends through and beyond the aperture 446 in the cover plate 444 and the aperture 462 in the open bearing retainer plate 426A to the outside of the casing 12. The splined region 472I includes a radially outwardly spaced portion 476I adjacent the annular shoulder 424I; this radially outwardly spaced portion 478I receives one of the tapered roller bearings 422 as described in greater detail below.

Similarly, the output shaft 416 has an output sprocket 450, an annular shoulder 424O adjacent the output sprocket 450, and a splined region 472O having a plurality of longitudinally extending splines 474O and extending from adjacent the annular shoulder 426O to a radially inwardly spaced threaded terminus 476O of the input shaft 416, and includes a radially outwardly spaced portion 4780 adjacent the annular shoulder 424O which will receive one of the tapered roller bearings 422. As with the splined region 472I, when installed the splined region 472O extends through and beyond the aperture 446 in the cover plate 444 and the aperture 462 in the open bearing retainer plate 426A.

Referring now to FIG. 8, the end of the input shaft 414 disposed outside of the casing 412 receives an input connector 480I. The input connector 480I has a splined receiving aperture 482I which mates with the splined region 472I of the input shaft 414 and which opens into a wider fastening recess 484I. When the input connector 480I is slid over the splined region 472I of the input shaft 414, the threaded terminus 476I of the input shaft 414 will extend past the splined receiving aperture 482I into the fastening recess 484I to receive a nut (not shown). This enables the input connector 480I to be secured to the input shaft 414 by tightening the nut on the threaded terminus 476I of the input shaft 414 against the annular shoulder 485I between the splined receiving aperture 482I and the wider fastening recess 484I. The input connector 480I includes a plurality of circumferentially spaced threaded apertures 486I so that the input connector 480I can be bolted to a shaft (not shown), such as a mainshaft, to receive rotary input from an engine.

Similarly, the end of the output shaft 416 disposed outside of the casing 412 receives a driveshaft connector 480D by way of a splined receiving aperture 482D in the driveshaft connector 480D which opens into a wider fastening recess 484D to enable a nut (not shown) to be threaded onto the threaded terminus 476O of the output shaft 416 and tightened against the annular shoulder 485D between the splined receiving aperture 482D and the wider fastening recess 484D. Like the input connector 480I, the driveshaft connector 480D includes a plurality of circumferentially spaced threaded apertures 486D so that it can be bolted to a driveshaft (not shown) for driving a vehicle axle. In the illustrated embodiment, a removable annular endcap 488 is provided for the driveshaft connector 480D. The endcap 488 has circumferentially spaced apertures 490 that mate with the circumferentially spaced threaded apertures 486D on the driveshaft connector 480D, and the driveshaft connector 480D and the endcap 488 include opposed annular recesses 492D and 492E enabling a suitably apertured brake disk 494 to be sandwiched between the driveshaft connector 480D and the endcap 488 before the driveshaft connector 480D and the endcap 488 are bolted to the driveshaft (not shown).

FIG. 4 shows the exemplary transfer case 410 with the input connector 480I secured to the input shaft 414 and the driveshaft connector 480D secured to the output shaft 416.

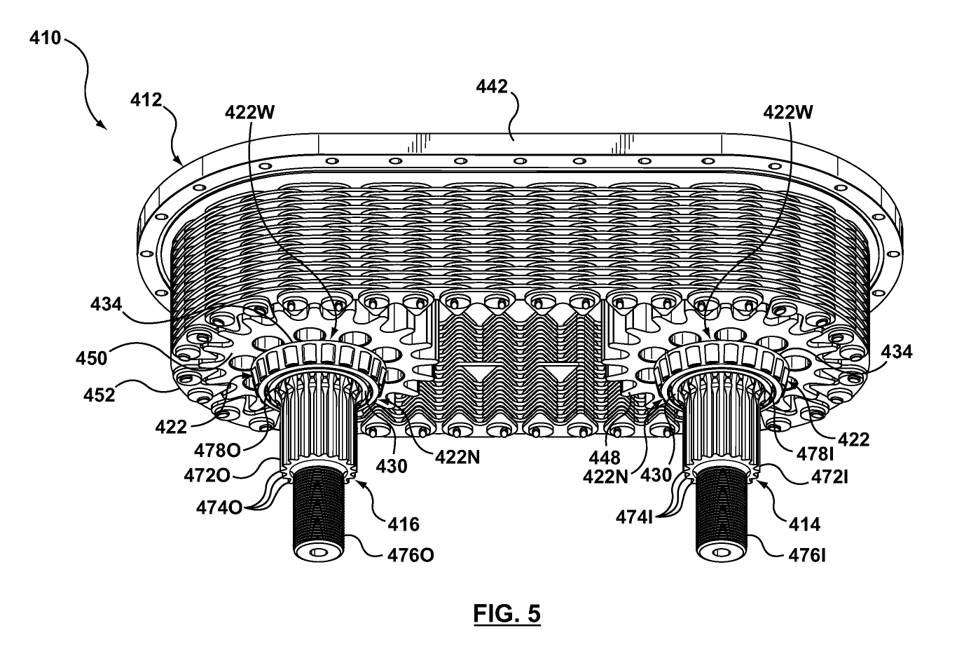

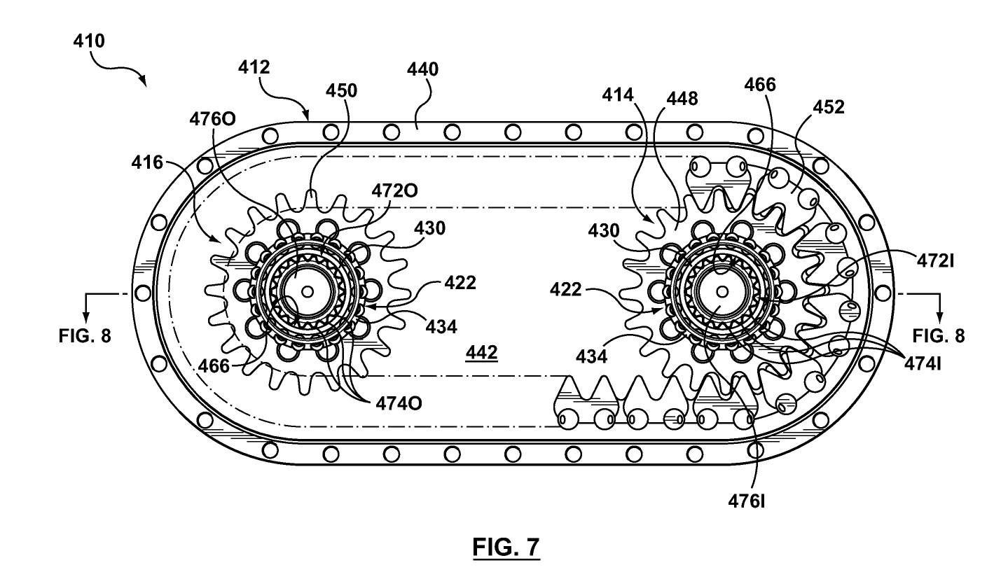

The input shaft 414 is rotationally coupled to the output shaft 416 inside the casing 412 so that rotation of the input shaft 414 drives rotation of the output shaft 416. This is best seen in FIG. 5, which is a perspective view of the transfer case 410 with the enclosure wall portion 440 and one of the cover plates 444 removed, and in FIG. 7, which is a top view of the transfer case 410 with one of the cover plates 444 removed. In the exemplary embodiment, the input sprocket 448 and the output sprocket 450 are coupled to one another by a chain loop 452 of multi-layer roller chain. The sprockets 448, 450 may be integrally formed as part of the respective shaft 414, 416 or may be separate elements secured to the respective shaft 414, 416 by any suitable technique. The input sprocket 448, output sprocket 450 and chain loop 452 are each disposed inside the casing 412, along with a sufficient quantity of lubricant. The cover plate 444 includes a suitable threaded fill hole 495 and threaded drain hole 496 (see FIGS. 4 and 6) for adding and removing lubricant, respectively. The fill hole 495 and drain hole 496 can be closed with a bolt and washer, and the casing 412 is suitably sealed to inhibit leakage of lubricant from inside the casing 412, as described in greater detail below. The fill hole 495 and drain hole 496 are positioned so that in the event that maintenance personnel fail to close either or both holes, a small quantity of lubricant will remain in the casing 412 to avoid unlubricated operation.

Referring again to FIGS. 6 and 8, in the illustrated embodiment, the closed bearing retainer plates 426 and the open bearing retainer plates 426A are removably secured to the cover plates 442, 444, respectively, over the apertures 446 by way of bolts, with the apertures 462 in the bearing retainer plates 426A being in registration with the apertures 446 in the cover plate 444. A ring seal 460 is received in an annular recess 461 on the inside face of each of the bearing retainer plates 426, 426A and squeezed between each of the bearing retainer plates 426, 426A and corresponding cover plates 442, 444 to inhibit leakage of lubricant.

The apertures 462 through the open bearing retainer plates 426A are smaller than the corresponding apertures 446 in the cover plate 444, such that the inside surface of each open bearing retainer plate 426A defines an annular shoulder 464 relative to the respective aperture 446 in the cover plate 444. The apertures 446 in the cover plate 444, together with the corresponding annular shoulders 464, form the two open receptacles 458A for the tapered roller bearings 422. More particularly, the annular shoulder 464 will bear against the narrow end 422N of the respective tapered roller bearing 422 when the tapered roller bearing 422 is installed in the open receptacle 458A. A ring seal 470 is press fit into a radially outwardly recessed portion 468 of each of the apertures 462 through the open bearing retainer plates 426A to inhibit leakage of lubricant.

The closed bearing retainer plates 426 cooperate with the other cover plate 442 to define the two closed receptacles 458 for the tapered roller bearings 422. Specifically, each of the closed receptacles 458 is formed by one of the apertures 446 in the cover plate 442 and the inside surface of the corresponding closed bearing retainer plate 426, which will bear against the narrow end 422N of the respective tapered roller bearing 422 when the tapered roller bearing 422 is installed in the closed receptacle 458A.

As described above and as best seen in FIG. 8, the input shaft 414 and the output shaft 416 are rotatably supported in the case by opposed annular tapered roller bearings 422 which are secured about the input and output shafts 414, 416 and securely carried by the casing 412, with the tapered roller bearings 422 oriented so that their narrow ends 422N point outwardly relative to the casing 412 and the tapered roller bearings 422 are squeezed between the input and output shafts 414, 416 and the casing 412.

In the illustrated embodiment, the tapered roller bearings 422 are interference fit over each end of the input shaft 414 and output shaft 416 and are also interference fit into the receptacles 458, 458A. The tapered roller bearings 422 that are disposed in the open receptacles 458A are friction fit over the radially outwardly spaced portions 476I, 476O of the splined regions 474I, 474O of the input shaft 414 and output shaft 416, respectively.

The input shaft 414 and the output shaft 416 include respective annular shoulders 424I, 424O adjacent the ends of the input sprocket 448 and output sprocket 450; these annular shoulders 424I, 424O receive the wide ends 422W of the respective tapered roller bearings 422. As used herein, the term “wide end”, when applied to a tapered roller bearing, refers to the end of the roller bearing from which the outside surface of the inner ring 430, the roller cage 434 and the inner surface of the outer ring 432 are tapered. Alternatively, the ends of the input sprocket 448 and output sprocket 450 may serve as an annular shoulder for receiving the wide ends 422W of the respective tapered roller bearings 422. The inside surfaces of the bearing retainer plates 426, 426A receive the narrow ends 422N of the tapered roller bearings 422. Thus, the tapered roller bearings 422 can be squeezed between the annular shoulders 424I, 424O and the bearing retainer plates 426, 426A, and hence between the shafts 414, 416 and the casing 412, by tightening the bearing retainer plates 426, 426A against the respective cover plates 442, 444. In the illustrated embodiment, the bearing retainer plates 426, 426A can be tightened against the cover plates 442, 444 by tightening the bolts that secure the bearing retainer plates 426, 426A to the cover plates 442, 444.

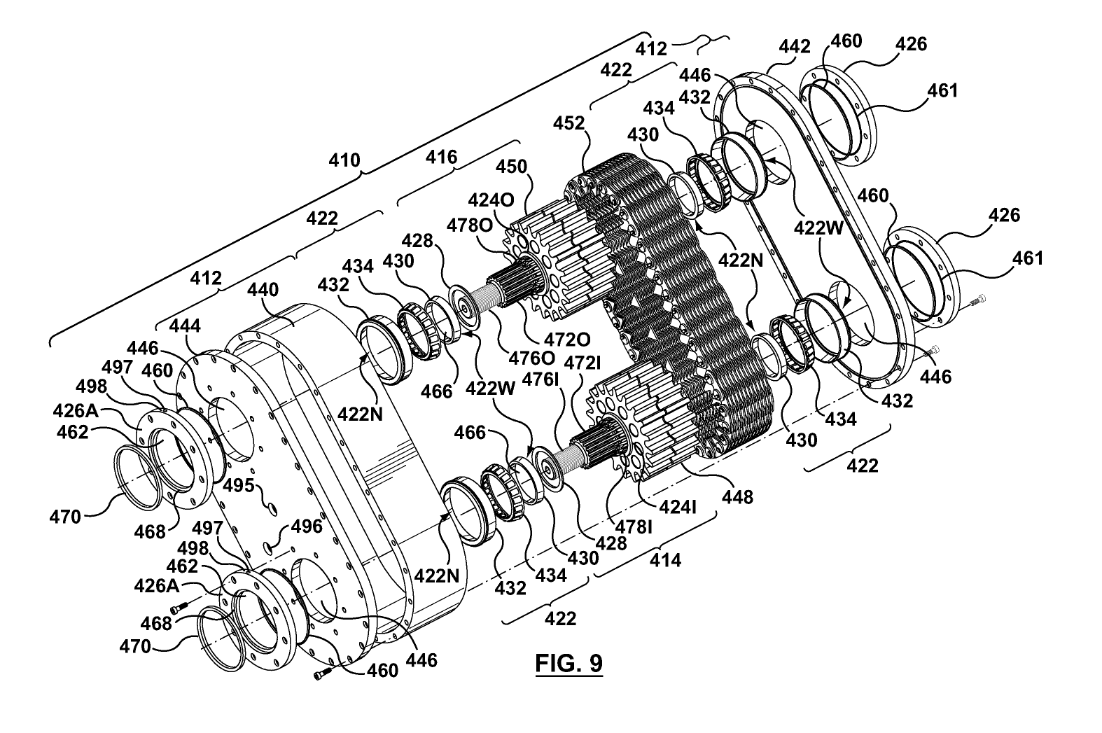

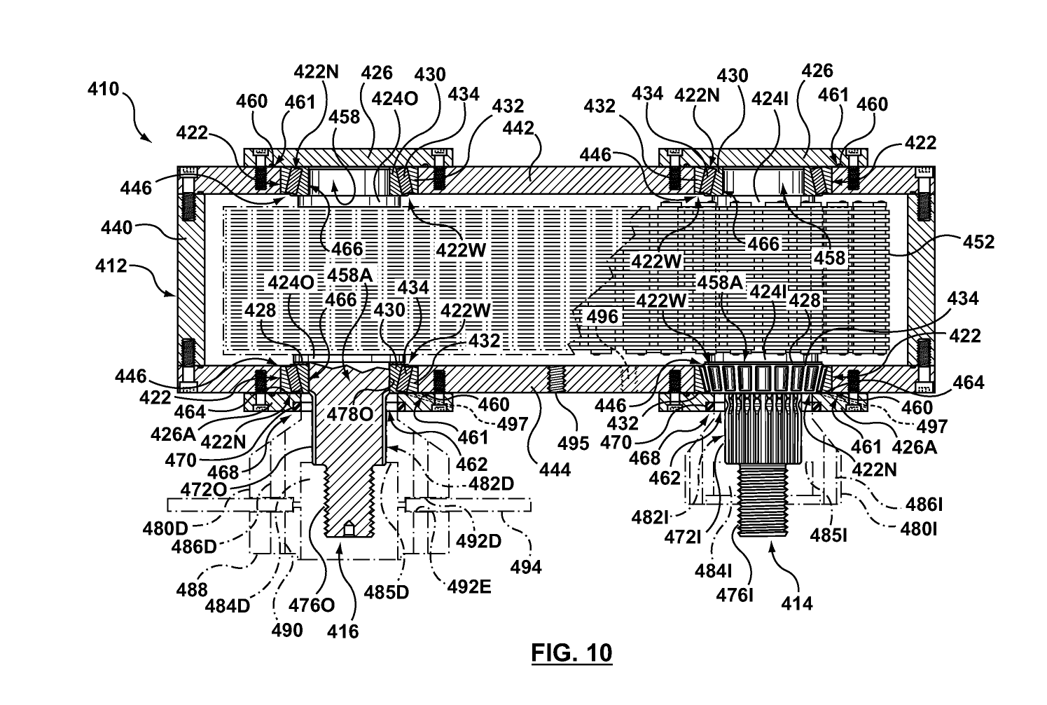

In addition, the tapered roller bearings 422 are adjustable to limit play between the shafts 414, 416 and the casing 412. In case of loosening of one of the tapered roller bearings 422, the transfer case can be repaired simply by interposing an annular shim 428 of suitable thickness between the wide end 422W of the tapered roller bearing 422 and the annular shoulder 424I, 424O, as shown in FIGS. 9 and 10, which are identical to FIGS. 6 and 8, respectively except that an annular shim 428 has been installed on the input shaft 414. Preferably, when a significant thickness of shim 428 is to be installed, the shims 428 should be installed in equal-thickness pairs on each end of the shaft, between the wide ends 422W of each tapered roller bearing 422 and each annular shoulder 424I, 424O to provide balance and avoid undesirable tension in the chain 452.

An annular shim can be installed by removing the relevant bearing retainer plate 426, 426A from the cover plate 442, 444 and then removing the tapered roller bearing 422 from the relevant end of the relevant shaft 414, 416. The shim 428 can then be installed on the shaft 414, 416 and the tapered roller bearing 422 replaced on the shaft 414, 416, after which the relevant bearing retainer plate 426, 426A is again mounted and tightened against its respective cover plate 442, 444. The increase in the pressure applied to the tapered roller bearing 422 resulting from the interposition of the shim 428 between the annular shoulder 424I, 424O and the tapered roller bearing 422 will keep the tapered roller bearing 422 secure.

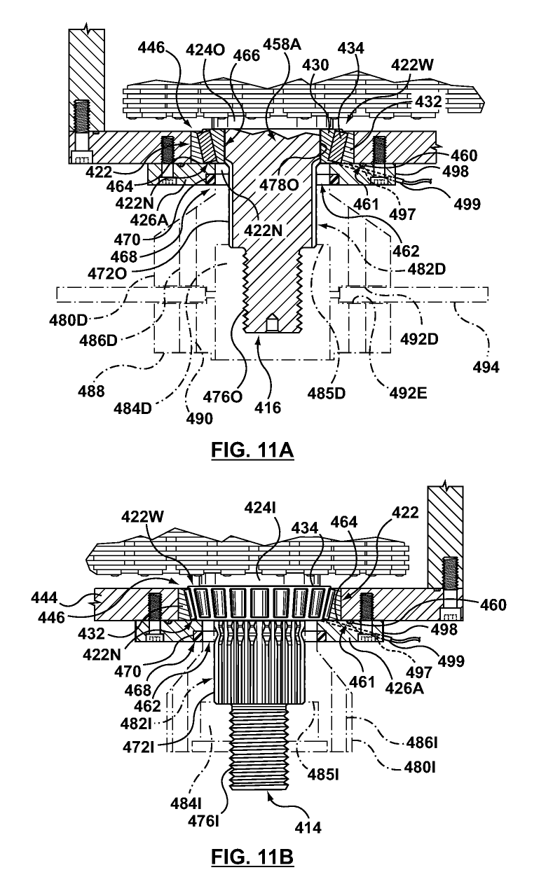

As shown in FIG. 11, each of the open bearing retainer plates 426A includes a vent aperture 497 to relieve pressure inside the casing 412. Each vent aperture 497 extends diagonally inwardly from the outer side edge 498 of the respective open bearing retainer plate 426A, past the annular recess 461 and ring seal 460 through to the annular shoulder 464 defined by the inside surface of the open bearing retainer plate 426A. The vent apertures 497 can then be sealingly coupled to ventilation tubing 499.

In a preferred embodiment, as many components as possible are interchangeable, so as to reduce manufacturing costs. For example, in the illustrated embodiment the input shaft and the output shaft are physically identical and interchangeable with one another. Similarly, the open bearing retainer plates 426A are physically identical and interchangeable, as are the closed bearing retainer plates 426. The input connector 480I and the driveshaft connector 480D are also physically identical components that can be interchanged, with the endcap 488 and brake disk 494 being supplemental components. The cover plates 442, 444 are identical except for the fill hole 495 and drain hole 496, which can be added at a later stage in the manufacturing process simply by tapping threaded apertures in the appropriate locations.

Several exemplary embodiments have been described and illustrated schematically, and a particular physical embodiment has been described by way of example. It will be apparent to persons skilled in the art that a number of variations and modifications can be made without departing from the scope of the invention as defined in the claims.

For example, in the exemplary transfer case 410, instead of using the sprocket and chain arrangement shown in FIGS. 4 to 10, the input shaft 414 may be rotationally coupled to the output shaft 416 by respective gears on the input shaft 414 and the output shaft 416, which gears may be coupled to one another either by direct meshing of the gears or by one or more intermediate gears, which may also be supported by opposed tapered roller bearings as described herein. Similarly, the casing 412 is merely one exemplary type of casing, and other suitable types of casing may also be used. For example, it is also contemplated that a casing for a transfer case according to an aspect of the present invention may be formed by casting a first part of the casing corresponding to both the enclosure wall portion 440 and one of the cover plates 442, 444 and casting a second part of the case corresponding to the other of the cover plates 442, 444.

The above description is intended in an illustrative rather than a restrictive sense. Variations to the exact embodiments described may be apparent to those skilled in the relevant art without departing from the spirit and scope of the claims set out below. It is intended that any such variations be deemed within the scope of this patent.

What is claimed is:

1. A transfer case, comprising:
a casing;
an input shaft;
at least one output shaft;
a rotational coupling inside the casing rotationally coupling the input shaft to the at least one output shaft;
the input shaft and the at least one output shaft each having an end disposed inside the housing and being rotatably supported by a respective opposed pair of tapered roller bearings extending between the casing and the respective shaft;
the tapered roller bearings being oriented so that the narrow ends of the tapered roller bearings in each pair of tapered roller bearings point away from one another; and
each of the tapered roller bearings being squeezed between the casing and its respective shaft.

2. The transfer case of claim 1, wherein the at least one output shaft comprises two output shafts.

3. The transfer case of claim 1, wherein the at least one output shaft comprises one output shaft.

4. The transfer case of claim 1, further comprising an adjustment mechanism for maintaining each of the tapered roller bearings being squeezed between the casing and its respective shaft.

5. The transfer case of claim 4, wherein the adjustment mechanism comprises the casing having at least one removably mounted bearing retention member providing access to a respective at least one of the tapered roller bearings to enable an annular shim to be interposed between one of the tapered roller bearings and its respective shaft.

6. A transfer case, comprising:
a casing;
an input shaft extending from outside the casing to inside the casing;
at least one output shaft extending from inside the casing to outside the casing;
a rotational coupling inside the casing rotationally coupling the input shaft to the at least one output shaft;
each of the input shaft and the at least one output shaft being rotatably supported by a respective opposed pair of tapered roller bearings extending between the casing and the respective shaft;
the tapered roller bearings being oriented so that the narrow ends of the tapered roller bearings in each pair of tapered roller bearings point away from one another; and
each of the tapered roller bearings being squeezed between the casing and its respective shaft.

7. The transfer case of claim 6, wherein the tapered roller bearings are interference fit over the shafts and interference fit into opposed receptacles in the casing.

8. The transfer case of claim 6, wherein the input shaft and the at least one output shaft each include respective annular shoulders which cooperate with the casing to squeeze the tapered roller bearings.

9. The transfer case of claim 8, wherein at least one annular shim is interposed between at least one of the annular shoulders and at least one corresponding tapered roller bearing for squeezing that tapered roller bearing.

10. The transfer case of claim 6, wherein the at least one output shaft comprises two output shafts.

11. The transfer case of claim 6, wherein the at least one output shaft comprises one output shaft.

12. The transfer case of claim 6, further comprising an adjustment mechanism for maintaining each of the tapered roller bearings being squeezed between the casing and its respective shaft.

13. The transfer case of claim 12, wherein the adjustment mechanism comprises the casing having at least one removably mounted bearing retention member providing access to a respective at least one of the tapered roller bearings to enable an annular shim to be interposed between one of the tapered roller bearings and its respective shaft.

14. A transfer case, comprising:
a casing;
at least two shafts rotatably supported by the casing with one end of each shaft disposed inside the casing and one end of each shaft disposed outside the casing;
the at least two shafts rotationally coupled together by a rotational coupling inside the casing;
each of the at least two shafts being located relative to the casing by a pair of opposed tapered roller bearings extending between the casing and the respective shaft with narrow ends of the tapered roller bearings pointed away from one another;
the tapered roller bearings being adjustable to limit play between the shafts and the casing.

15. The transfer case of claim 14, wherein the tapered roller bearings are interference fit over the shafts and interference fit into opposed receptacles in the casing.

16. The transfer case of claim 14, wherein the input shaft and the at least one output shaft each include respective annular shoulders which cooperate with the casing to squeeze the tapered roller bearings.

17. The transfer case of claim 16, wherein the tapered roller bearings are adjustable to limit play between the shafts and the casing by at least one removable bearing retention member providing access to a respective at least one of the tapered roller bearings to enable an annular shim to be interposed between one of the tapered roller bearings and its respective shaft.

18. The transfer case of claim 17, wherein the at least two shafts comprise an input shaft and a single output shaft.

19. The transfer case of claim 17, wherein the at least two shafts comprise an input shaft and two output shafts.
